(19) United States
(12) Patent Application Publication
(10) Pub. No.: US 2016/0138510 A1
(43) Pub. Date: May 19, 2016

(54) ENGINE CONTROL APPARATUS

(71) Applicant: WESTPORT POWER INC., Vancouver (CA)

(72) Inventors: Mathieu P. BOUVIER, North Vancouver (CA); Justin DUAN, Burnaby (CA); Wei FEI, Burnaby (CA); Fadi KANAFANI, Richmond (CA)

(21) Appl. No.: 14/900,956

(22) PCT Filed: Jun. 20, 2014
(86) PCT No.: PCT/CA2014/050581

§ 371 Date: Dec. 22, 2015

(30) Foreign Application Priority Data
Jun. 27, 2013 (CA) 2,819,721

(51) Int. Cl. F02D 41/30; F02B 1/02; F02M 31/18; F02D 19/02; F02M 21/06; F02M 21/02

(52) U.S. Cl. CPC F02D 41/3005; F02M 21/06; F02M 21/0221; F02M 21/0275; F02M 21/0278; F02M 31/18; F02D 19/027; F02D 19/024; F02B 1/02

(57) ABSTRACT

Engines fuelled with gaseous fuel stored in liquefied form comprise different strategies and controls for managing gaseous fuel compared to other systems, previously resulting in an ad hoc arrangements of controllers. An engine control apparatus comprises an internal combustion engine fuelled with a gaseous fuel stored in liquefied form and a control unit programmed with a fuel system module, for monitoring gaseous fuel pressure and actuating a fuel injection apparatus for introducing gaseous fuel into a combustion chamber, and a liquefied gaseous fuel module, for monitoring the quantity of liquefied gaseous fuel remaining in a storage vessel and controlling a pumping apparatus that pumps liquefied gaseous fuel from the storage vessel to a vaporizer. The fuel system control module and the liquefied gaseous fuel control module cooperate to introduce gaseous fuel in the combustion chamber at a predetermined pressure as a function of engine operating conditions.

### FIELD OF THE INVENTION

The present application relates to an engine control apparatus for controlling an internal combustion engine fuelled with a gaseous fuel, and more particularly with a gaseous fuel stored in liquefied form.

### BACKGROUND OF THE INVENTION

Modern automobiles and trucks typically employ several control units to manage the various components associated with an internal combustion engine and the vehicle in general. Typically, there is a base engine control unit for managing the internal combustion engine and a number of additional control units distributed throughout the vehicle for managing off engine components. The trend in modern automobile control design is to employ multiple distributed dedicated controllers that manage specific functions and tasks, and which communicate with the base engine control unit. The base engine control unit is a type of electronic control unit that controls a series of actuators on the engine to ensure the engine is operating within predetermined parameters. A multitude of sensors connected with the base engine control unit supply sensor values that reflect the various operational parameters of the engine.

An additional fuel system control unit is normally added when a vehicle is converted, or adapted to be fuelled with a gaseous fuel such as natural gas. The fuel system control unit comprises a fuel system module responsible for monitoring the pressure and commanding the injection of the gaseous fuel. When the gaseous fuel is stored in liquefied form it is known to employ yet another control unit, a liquefied gaseous fuel control unit. The liquefied gaseous fuel control unit comprises a liquefied gaseous fuel module for monitoring the quantity of gaseous fuel in the storage vessel, managing the pumping of the liquefied gaseous fuel and monitoring the pressure and temperature of vaporized gaseous fuel. Compared to conventional liquid fuel systems and gaseous fuel systems that employ compressed natural gas, a fuel system employing the liquefied gaseous fuel control unit comprises different strategies and controls for managing the gaseous fuel in liquefied form compared to these other systems.

The additional control units typically communicate with the base engine control unit over a J1939 interface, which is the vehicle bus standard used for communication and diagnostics among vehicle components, although other electronic communication buses can be employed. FIG. 1 illustrates an engine apparatus 10 comprising a base engine control unit 20 operatively connected with internal combustion engine apparatus 60 and communicating with fuel system control unit 30 and liquefied gaseous fuel control unit 40 over bus 50. Both fuel system control unit 30 and liquefied gaseous fuel control unit 40 are operatively connected with respective components within apparatus 60 as would be known by those skilled in the technology.

As used herein a control unit comprises a self-contained electronic controller. An electronic controller can comprise both hardware and software components. The hardware components can comprise digital and/or analog electronic components. As a non-limiting example, an electronic controller can comprise a processor and memories, including one or more permanent memories, such as FLASH, EEPROM and a hard disk, and a temporary memory, such as SRAM and DRAM, the various memories cooperating with the processor to store and execute a program. As used herein, the terms algorithm, module and step refer to an application specific integrated circuit (ASIC), an electronic circuit, a processor (shared, dedicated, or group) and memory that execute one or more software or firmware programs, a combinational logic circuit, and/or other suitable components that provide the described functionality. In preferred embodiments the algorithms, modules and steps herein are part of a control unit.

When converting a vehicle to be fuelled with gaseous fuel, using separate control units is an easier and obvious approach because it minimizes changes to the vehicles existing control unit that might still be used, for example for a bi-fuel vehicle that can be fuelled with either liquid fuel or gaseous fuel. However, separate control units create a packaging and mounting challenge for vehicle system integrators where space under the hood in modern engines is limited. Power and communication harnesses need to be routed to the additional control units presenting other potential points of failure in the engine electrical system. There is an increased burden when developing software for each control unit that must intercommunicate with other control units. Communication protocols must be developed for exchanging and requesting information between these control units. In modern high speed engines there can be time constraints that make inter-control unit communication a potential bottle neck for receiving and/or responding to engine events due to the limited bandwidth between the control units thereby limiting the control bandwidth of the engine and possibly the maximum engine speed. The complexity of software maintenance and deployment is increased in a multi-control unit environment. Multiple releases of software need to be managed separately and independently of each other, and software must be deployed to multiple control units when upgrades are required. When a module in one control unit requires information from another control unit then software modules in both control units require updating.

The state of the art is lacking in techniques for integrating additional control modules in the existing engine control apparatus in engines that have been converted or adapted to be fuelled with an alternative fuel, such as a gaseous fuel.

### SUMMARY OF THE INVENTION

An improved engine control apparatus comprising an internal combustion engine fuelled with a gaseous fuel stored in liquefied form comprising a control unit programmed with a fuel system module for monitoring gaseous fuel pressure and actuating a fuel injection apparatus for introducing gaseous fuel into a combustion chamber of the internal combustion engine; and a gaseous fuel module for monitoring the quantity of liquefied gaseous fuel remaining in a storage vessel and controlling a pumping apparatus that pumps liquefied gaseous fuel from the storage vessel to a vaporizer; wherein the fuel system control module and the liquefied gaseous fuel control module cooperate to introduce gaseous fuel in the combustion chamber at a predetermined pressure as a function of engine operating conditions. In a preferred embodiment the internal combustion engine apparatus is further fuelled with a liquid fuel, the fuel system control module further monitors and controls liquid fuel pressure and actuates the fuel injection apparatus to introduce liquid fuel into the combustion chamber.

The fuel injection apparatus can introduce gaseous fuel directly into said combustion chamber, or upstream of an intake valve associated with the combustion chamber. The control unit can be further programmed to actuate a positive ignition source. The engine apparatus can further comprise a base engine control unit programmed with a base engine module. The base engine module monitors at least one of inlet manifold temperature, inlet manifold pressure, engine coolant temperature, oil pressure, oil temperature, exhaust gas oxygen concentration, engine speed, engine position and ignition switch position. The base engine module can be programmed to command a throttle valve actuator.

An improved apparatus comprises an internal combustion engine fuelled with a gaseous fuel. The apparatus comprises a liquefied gaseous fuel storage vessel. A liquefied gaseous fuel measuring apparatus provides a signal representative of the quantity of liquefied gaseous fuel remaining in the liquefied gaseous fuel storage vessel. A gaseous fuel pumping apparatus pumps liquefied gaseous fuel from the liquefied gaseous storage vessel. A vaporizer evaporates liquefied gaseous fuel received from the gaseous fuel pumping apparatus. A gaseous fuel pressure sensor generates signals representative of gaseous fuel pressure downstream from the vaporizer. A fuel injection apparatus introduces gaseous fuel received from the vaporizer into a combustion chamber of the internal combustion engine. A control unit is programmed to determine actual gaseous fuel pressure as a function of the signals representative of gaseous fuel pressure; actuate the gaseous fuel pumping apparatus to maintain actual gaseous fuel pressure within a predetermined range of tolerance; actuate the fuel injection apparatus to introduce gaseous fuel into the combustion chamber; and determine an actual quantity of liquefied gaseous fuel remaining in the liquefied gaseous fuel storage vessel as a function of the signals representative of the quantity of liquefied gaseous fuel remaining in the liquefied gaseous fuel storage vessel. In a preferred embodiment, the internal combustion engine is also fuelled with a liquid fuel. The engine apparatus further comprises a liquid fuel storage vessel. A liquid fuel pumping apparatus pumps liquid fuel from the liquid fuel storage vessel. A liquid fuel pressure sensor generating signals representative of liquid fuel pressure downstream from the liquid fuel pumping apparatus. The engine control unit is further programmed to determine liquid fuel pressure as function of the signals representative of liquid fuel pressure; actuate the liquid fuel pumping apparatus to maintain actual liquid fuel pressure within a predetermined range of tolerance; and actuate the fuel injection apparatus to introduce liquid fuel into the combustion chamber.

In a preferred embodiment the signals representative of gaseous fuel pressure are representative of gaseous fuel pressure downstream from a vaporizer, also known as accumulator pressure, and the signals representative of liquid fuel pressure are representative of liquid fuel rail pressure. The liquid fuel can be a pilot fuel. The engine apparatus further comprises a positive ignition source for igniting the gaseous fuel, wherein the control unit is programmed to actuate the positive ignition source. The positive ignition source can be one of a spark igniter, a radio frequency (RF) igniter and a laser igniter. The engine apparatus can further comprise a throttle valve and a throttle valve actuator, wherein the control unit is programmed to actuate the throttle valve actuator. The control unit can be programmed to monitor at least one of inlet manifold temperature, inlet manifold pressure, engine coolant temperature, oil pressure, oil temperature, exhaust gas oxygen concentration, engine speed, engine position and ignition switch position.

An improved engine control apparatus comprises an internal combustion engine fuelled with gaseous fuel. The engine apparatus comprises a control unit programmed to monitor gaseous fuel pressure; control a gaseous fuel pumping apparatus to pump liquefied gaseous fuel; actuate a fuel injection apparatus to introduce gaseous fuel into a combustion chamber of said internal combustion engine; and monitor the quantity of liquefied gaseous fuel remaining in a liquefied gaseous fuel storage vessel. In a preferred embodiment, the internal combustion engine is also fuelled with a liquid fuel. The control unit is further programmed to monitor liquid fuel pressure; control a liquid fuel pumping apparatus to pump liquid fuel; and actuate said fuel injection apparatus to introduce liquid fuel into said combustion chamber. The control unit can be programmed to actuate a positive ignition source. The control unit is programmed to monitor at least one of inlet manifold temperature, inlet manifold pressure, engine coolant temperature, oil pressure, oil temperature, exhaust gas oxygen concentration, engine speed, engine position and ignition switch position. The control unit can be programmed to command a throttle valve actuator.

### BRIEF DESCRIPTION OF THE DRAWINGS

FIG. 1 is a schematic view of a known engine control apparatus and an internal combustion engine fuelled with a liquefied gaseous fuel.

FIG. 2 is a schematic view of an engine system fuelled with a liquid fuel and a gaseous fuel according to a first embodiment.

FIG. 3 is a schematic view of a liquid fuel supply apparatus of the engine system of FIG. 2.

FIG. 4 is a schematic view of a gaseous fuel supply apparatus of the engine system of FIG. 2.

FIG. 5 is a schematic view of an internal combustion engine apparatus of the engine system of FIG. 2.

FIG. 6 is a schematic view of an engine system fuelled with a gaseous fuel according to a second embodiment.

FIG. 7 is a schematic view of an internal combustion engine apparatus of the engine system of FIG. 6.

FIG. 8 is a schematic view of an engine system fuelled with a liquid fuel and a gaseous fuel according to a third embodiment.

FIG. 9 is a schematic view of an engine system fuelled with a gaseous fuel according to a fourth embodiment.

### DETAILED DESCRIPTION OF PREFERRED EMBODIMENT(S)

In the description of the subject engine control apparatus a number of different embodiments are described, and in the figures like parts and components are indicated by like reference numerals and if essentially in the same form and function such parts and components already described may not be described in detail, if at all. In all the figures herein, dashed lines represent piping for fluid flow and the arrows on the dashed lines represents the direction of flow, solid lines with a single arrow represent unidirectional electrical communications, and solid lines with an arrow at each end represent bi-directional communication. The solid lines can represent a single wire or a grouping of wires.

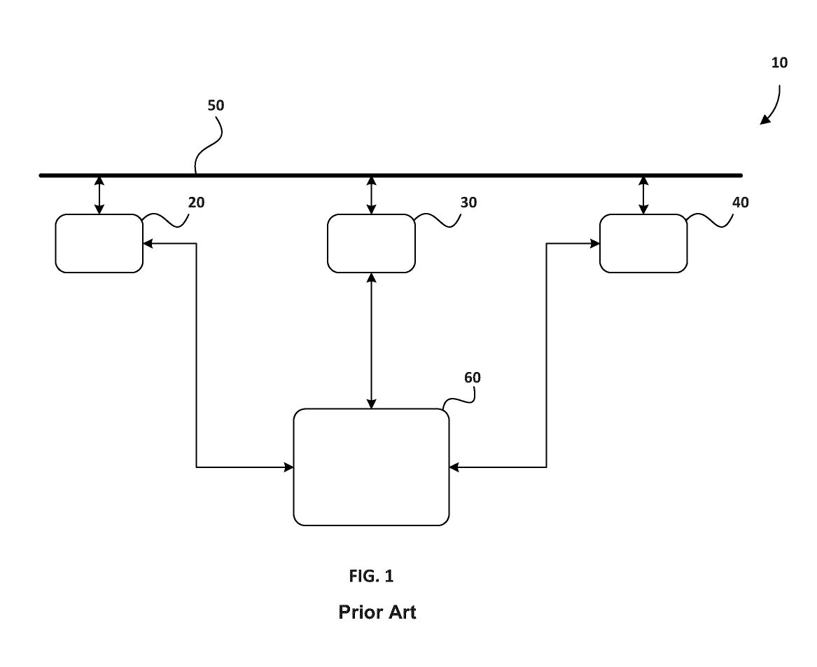

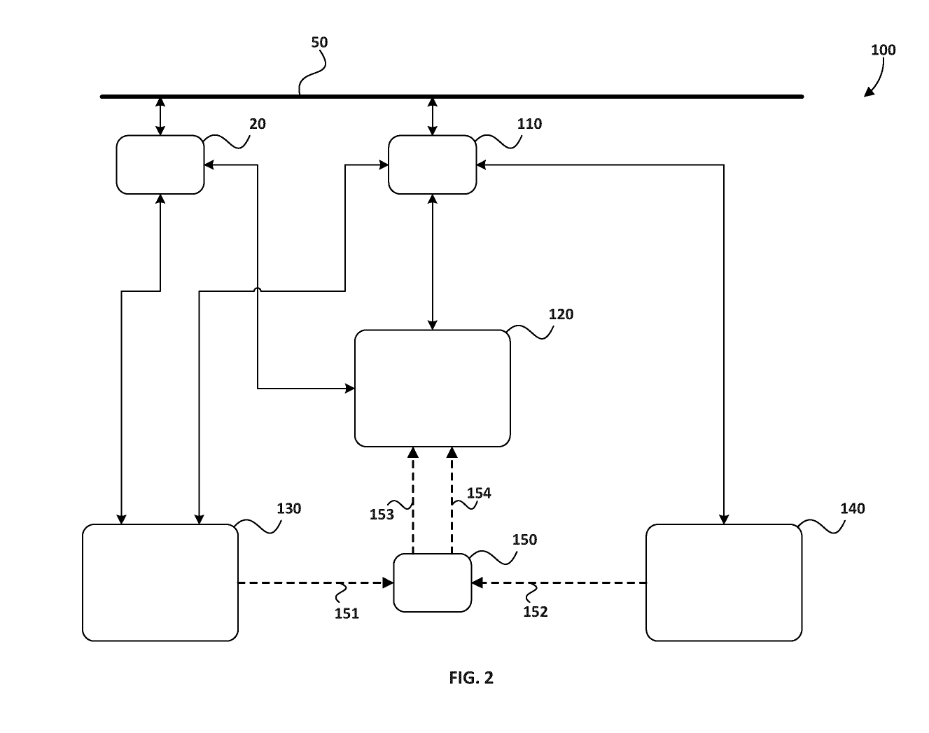

With reference to FIG. 2, engine system 100 comprises base engine control unit 20 and fuel system and liquefied gaseous fuel control unit 110, which communicate with each other over bus 50. Internal combustion engine apparatus 120 is fuelled with both a liquid fuel and a gaseous fuel. In a preferred embodiment the liquid fuel is a pilot fuel and the gaseous fuel is a main fuel. Liquid fuel supply apparatus 130 supplies liquid fuel and gaseous fuel supply apparatus 140 supplies gaseous fuel to liquid-gaseous fuel bias apparatus 150, which maintains a predefined bias pressure between liquid fuel and gaseous fuel. Base engine control unit 20 is operatively connected with apparatus 120 and liquid fuel supply apparatus 130. Fuel system and liquefied gaseous fuel control unit 110 is operatively connected with apparatus 120, liquid fuel supply apparatus 130 and gaseous fuel supply apparatus 140, and comprises a fuel system module and a liquefied gaseous fuel module, similar in function to the fuel system module and the liquefied gaseous fuel module of FIG. 1. Engine system 100 is advantageous when the alternative fuel system integrator does not have access to base engine control unit 20 to integrate the fuel system and the liquefied gaseous fuel modules. Further, the communications between the fuel system module and the liquefied gaseous fuel module can be simplified and the control bandwidth between these modules can be increased for improved gaseous fuel system and combustion control.

Referring now to FIG. 3, liquid fuel supply apparatus 130 is described in more detail. In the present embodiment, apparatus 130 is representative of a common rail liquid fuel supply system that transfers fuel from a storage vessel and then pressurizes the fuel to common rail pressure. Low pressure pump 132 pumps liquid fuel out of liquid fuel storage vessel 131 towards high pressure pumping apparatus 133. Pumping apparatus 133 pumps liquid fuel to a high pressure suitable for fuel injection and pressure sensor 134 generates signals representative of liquid fuel pressure. In a preferred embodiment, base engine control unit 20 commands pump 132 over wire 135, and the fuel system module in control unit 110 commands pumping apparatus 133 over wire 136. In other embodiments the fuel system module can command pump 132 as well. The fuel system module in control unit 110 receives the signal from pressure sensor 134 over wire 137. As would be known by those skilled in the technology, other components known to be employed in liquid fuel systems can be employed in supply apparatus 130. In other embodiments, liquid fuel supply apparatus 130 can employ a single pump for pressurizing fuel from storage vessel 131, and these embodiments are not required to be common rail systems.

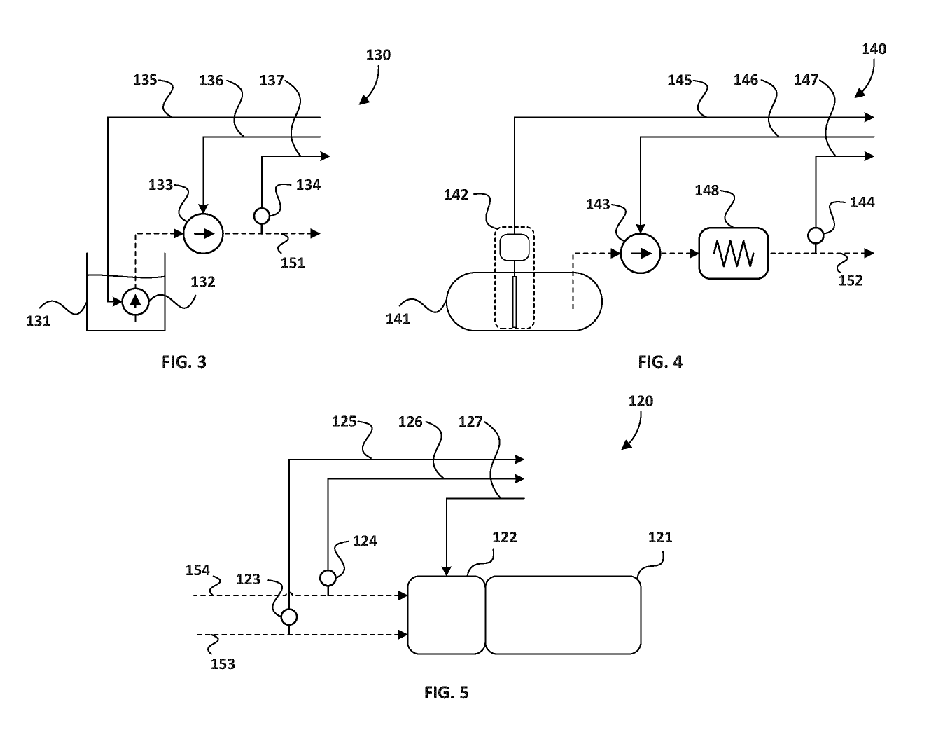

Referring now to FIG. 4, gaseous fuel supply apparatus 140 is described in more detail. Apparatus 140 comprises a pumping apparatus 143 that pumps liquefied gaseous fuel from liquefied gaseous fuel storage vessel 141 through vaporizer 148. Pressure sensor 144 generates signals representative of gaseous fuel pressure in piping 152, also known as accumulator pressure. Liquefied gaseous fuel measuring apparatus 142 generates a signal representative of the quantity of gaseous fuel remaining in storage vessel 141. In a preferred embodiment measuring apparatus 152 comprises a capacitance-type level sensor located in storage vessel 141 and an electronic module connected with the level sensor. The electronic module generates a measuring signal sent to the level sensor and receives a signal from the level sensor representative of the quantity of gaseous fuel remaining in storage vessel 141. The liquefied gaseous fuel module in control unit 110 commands pumping apparatus 143 over wire 146, and receives the signals from measuring apparatus 142 and pressure sensor 144 over wires 145 and 147 respectively. The liquefied gaseous fuel module determines a quantity of gaseous fuel remaining in vessel 141 as a function of the signal representative of the quantity of gaseous fuel remaining in storage vessel 141 received from measuring apparatus 142. As would be known by those skilled in the technology, other components known to be employed in gaseous fuel systems can be employed in supply apparatus 140.

With reference now to FIG. 5, internal combustion engine apparatus 120 is described in more detail. Apparatus 120 comprises fuel injection apparatus 122 operatively connected with internal combustion engine 121. Pressurized liquid fuel is delivered through piping 153 and pressurized gaseous fuel is delivered through piping 154 to fuel injection apparatus 122. In a preferred embodiment, apparatus 122 comprises a fuel injector (not shown) that introduces both liquid fuel and gaseous fuel (preferably separately and independently of each other) to a combustion chamber (not shown) of engine 121. In other embodiments there can be more than one combustion chamber and more than one fuel injector. In other embodiments apparatus 122 can comprise a first fuel injector for introducing liquid fuel and a second fuel injector for introducing gaseous fuel, and in these embodiments bias apparatus 150 is required when the second fuel injector is hydraulically actuated by the liquid fuel, but not necessarily required otherwise. The fuel system module in control unit 110 commands fuel injection apparatus 122 to inject liquid fuel and gaseous fuel over wire(s) 127. Pressure sensor 123 generates signals representative of liquid fuel pressure in piping 153, also known as liquid fuel rail pressure, and pressure sensor 124 generates signals representative of gaseous fuel pressure in piping 154, also known as gaseous fuel rail pressure. The fuel system module in control unit 110 receives the signals from pressure sensors 123 and 124 over wires 125 and 126 respectively.

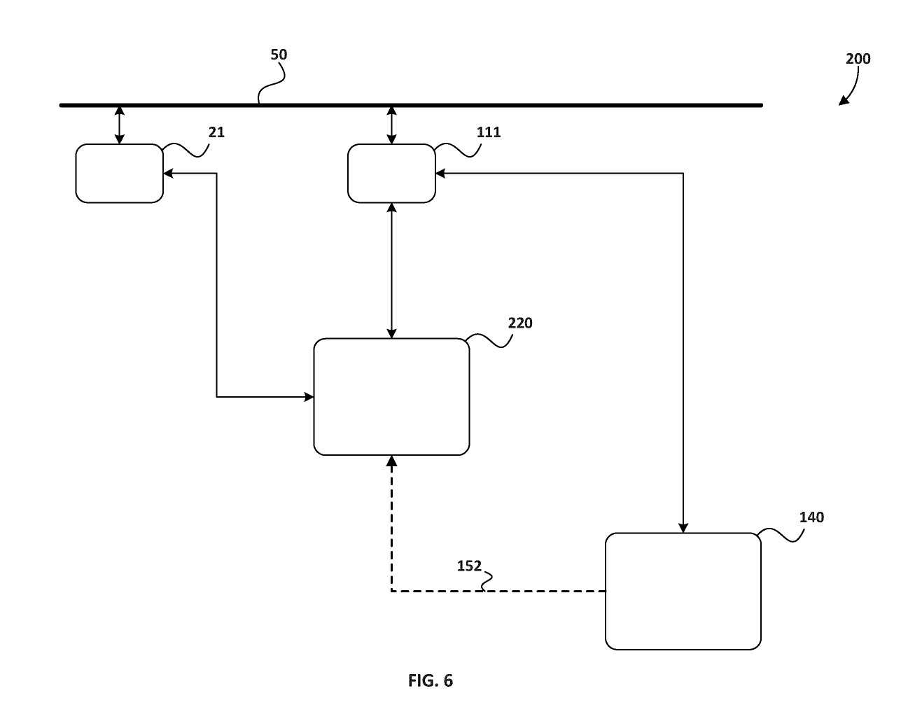

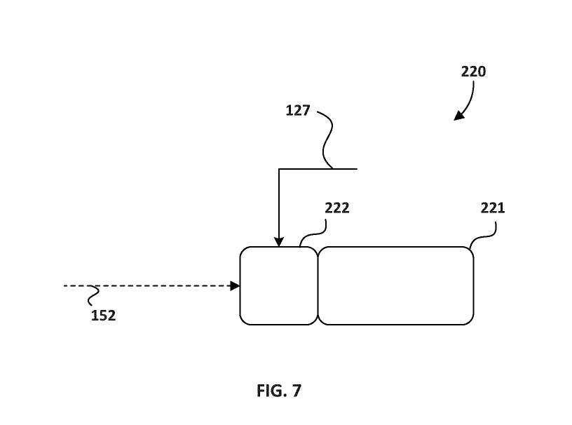

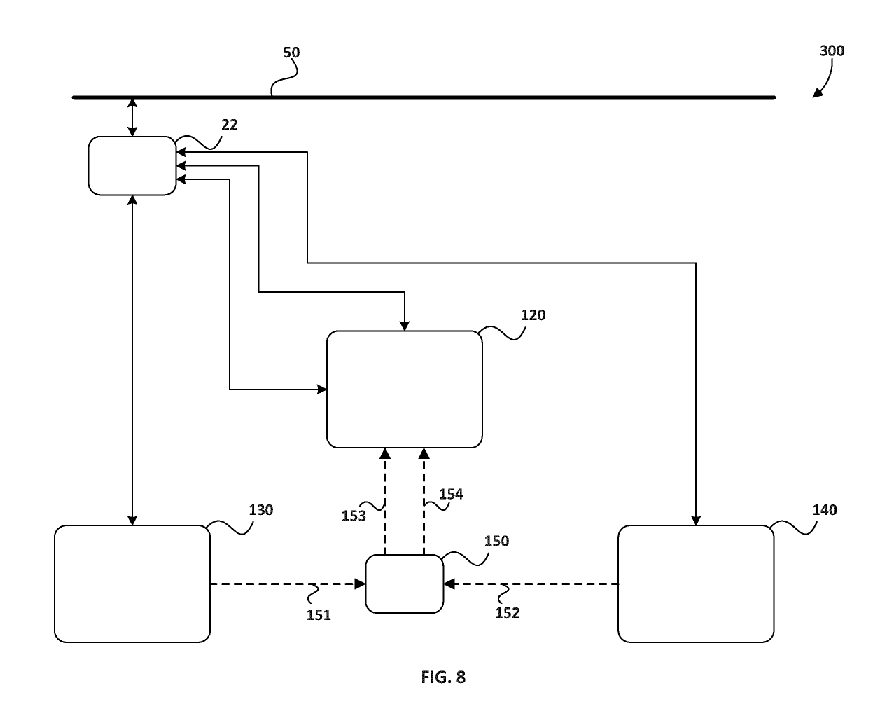

Referring now to FIGS. 6 and 7, there is shown another embodiment for an engine control apparatus for engine system 200, which can be employed to convert a conventional liquid fuelled engine to an engine fuelled only with a gaseous fuel. Engine system 200 comprises internal combustion engine apparatus 220 that is fuelled with gaseous fuel from supply apparatus 140. In a preferred embodiment the gaseous fuel is ignited with a positive ignition source such as a spark igniter, a radio frequency (RF) igniter or a laser igniter, however other ignition techniques can be employed. Apparatus 220 is similar to apparatus 120 of FIG. 2, and in this embodiment is fuelled with gaseous fuel delivered through piping 152 from supply apparatus 140. Referring to FIG. 7, engine apparatus 220 comprises an internal combustion engine 221 and fuel injection apparatus 222. Apparatus 222 comprises a fuel injector (not shown) that injects gaseous fuel either upstream of an intake valve (not shown) associated with a combustion chamber of engine 221, or directly into the combustion chamber. As would be known to those familiar with the technology there can be more than one combustion chamber and more than one fuel injector in other embodiments. Referring back to FIG. 6, base engine control unit 21 is similar to control unit 20 of FIG. 2, except that engine system 200 does not have a liquid fuel system and control unit 21 replaces the control unit normally used by the engine when fuelled only with a liquid fuel. In operation it is possible that control unit 21 is an adapted version of control unit 20 with the control logic for the liquid fuel system disabled or adapted for use with engine system 200. Fuel system and liquefied gaseous fuel control unit 111 comprises a fuel system module and a liquefied gaseous fuel module similar to control unit 110 of FIG. 2. The fuel system module in control unit 111 commands fuel injection apparatus 222 to inject gaseous fuel, and is not required to manage liquid fuel pressure or command a liquid fuel pumping apparatus.

Referring to FIG. 8, there is shown engine system 300, where base engine control unit 22 within a single engine control unit comprises a base engine module, similar in function to control unit 20, in addition to a fuel system module and a liquefied gaseous fuel module to serve the same function as control unit 110 in FIG. 2. Engine apparatus 300 is advantageous when the alternative fuel system integrator has access to base engine control unit 22 to integrate the fuel system and the liquefied gaseous fuel modules. Further, the communications between the base engine module, the fuel system module and the liquefied gaseous fuel module can be simplified and the control bandwidth between these modules can be increased for improved liquid and gaseous fuel system and combustion control.

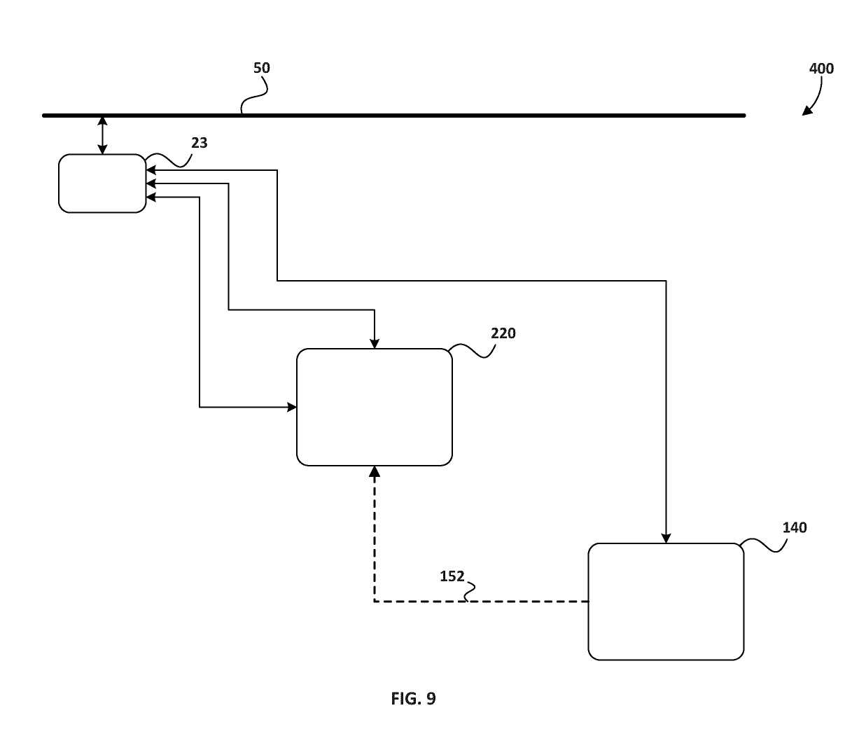

Referring to FIG. 9, there is shown engine system 400, where base engine control unit 23 comprises a base engine module to serve the function of separate control unit 21 as shown in FIG. 6, in addition to a fuel system module and a liquefied gaseous fuel module to function in the same way as separate control unit 111 as shown in FIG. 6. In embodiments where the base engine module actuates the fuel injectors to introduce gaseous fuel either directly into the combustion chambers of engine 221 (see FIG. 7) or upstream of intake valves associated with respective combustion chambers, then control unit 23 comprises a base engine module and a liquefied gaseous fuel module but does not comprise a fuel system module.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

1. An engine control apparatus comprising an internal combustion engine fuelled with a gaseous fuel stored in liquefied form comprising:
a control unit programmed with:
a fuel system module for monitoring gaseous fuel pressure and actuating a fuel injection apparatus for introducing gaseous fuel into a combustion chamber of said internal combustion engine; and
a gaseous fuel module for monitoring the quantity of liquefied gaseous fuel remaining in a storage vessel and controlling a pumping apparatus that pumps liquefied gaseous fuel from said storage vessel to a vaporizer;
wherein said fuel system control module and said gaseous fuel control module cooperate to introduce gaseous fuel in said combustion chamber at a predetermined pressure as a function of engine operating conditions.

2. The engine control apparatus of claim 1, wherein said fuel injection apparatus introduces gaseous fuel directly into said combustion chamber.

3. The engine control apparatus of claim 1, wherein said fuel injection apparatus introduces gaseous fuel upstream of an intake valve associated with said combustion chamber.

4. The engine control apparatus of claim 1, wherein said internal combustion engine apparatus is further fuelled with a liquid fuel, said fuel system control module further monitors and controls liquid fuel pressure and actuates said fuel injection apparatus to introduce liquid fuel into said combustion chamber.

5. The engine control apparatus of claim 1, wherein said control unit is further programmed to actuate a positive ignition source.

6. The engine control apparatus of claim 1, further comprising a base engine control unit programmed with a base engine module.

7. The engine control apparatus of claim 6, wherein said base engine module monitors at least one of inlet manifold temperature, inlet manifold pressure, engine coolant temperature, oil pressure, oil temperature, exhaust gas oxygen concentration, engine speed, engine position and ignition switch position.

8. The engine control apparatus of claim 6, wherein said base engine module is programmed to command a throttle valve actuator.

9. An apparatus comprising an internal combustion engine fuelled with a gaseous fuel comprising:
a liquefied gaseous fuel storage vessel;
a liquefied gaseous fuel measuring apparatus for providing a signal representative of the quantity of liquefied gaseous fuel remaining in said liquefied gaseous fuel storage vessel;
a gaseous fuel pumping apparatus for pumping liquefied gaseous fuel from said liquefied gaseous storage vessel;
a vaporizer for evaporating liquefied gaseous fuel received from said gaseous fuel pumping apparatus;
a gaseous fuel pressure sensor generating signals representative of gaseous fuel pressure downstream from said vaporizer;
a fuel injection apparatus for introducing gaseous fuel received from said vaporizer into a combustion chamber of said internal combustion engine; and
a control unit programmed to:
determine actual gaseous fuel pressure as a function of said signals representative of gaseous fuel pressure;
actuate said gaseous fuel pumping apparatus to maintain actual gaseous fuel pressure within a predetermined range of tolerance;
actuate said fuel injection apparatus to introduce gaseous fuel into said combustion chamber; and
determine an actual quantity of liquefied gaseous fuel remaining in said liquefied gaseous fuel storage vessel as a function of said signals representative of the quantity of liquefied gaseous fuel remaining in said liquefied gaseous fuel storage vessel.

10. The apparatus of claim 9, wherein said signals representative of gaseous fuel pressure are representative of accumulator pressure.

11. The apparatus of claim 9, wherein said internal combustion engine is fuelled with a liquid fuel, further comprising:
a liquid fuel storage vessel;
a liquid fuel pumping apparatus for pumping liquid fuel from said liquid fuel storage vessel;
a liquid fuel pressure sensor generating signals representative of liquid fuel pressure downstream from said liquid fuel pumping apparatus; and
said engine control unit further programmed to:
determine liquid fuel pressure as function of said signals representative of liquid fuel pressure;
actuate said liquid fuel pumping apparatus to maintain actual liquid fuel pressure within a predetermined range of tolerance; and
actuate said fuel injection apparatus to introduce liquid fuel into said combustion chamber.

12. The apparatus of claim 11, wherein said signals representative of liquid fuel pressure are representative of liquid fuel rail pressure.

13. The apparatus of claim 11, wherein said liquid fuel is a pilot fuel.

14. The apparatus of claim 10, further comprising a positive ignition source for igniting said gaseous fuel, said control unit programmed to actuate said positive ignition source.

15. The apparatus of claim 14, wherein said positive ignition source is one of a spark igniter, a radio frequency (RF) igniter and a laser igniter.

16. The apparatus of claim 10, further comprising a throttle valve and a throttle valve actuator, said control unit programmed to actuate said throttle valve actuator.

17. The apparatus of claim 10, wherein said control unit is programmed to monitor at least one of inlet manifold temperature, inlet manifold pressure, engine coolant temperature, oil pressure, oil temperature, exhaust gas oxygen concentration, engine speed, engine position and ignition switch position.

18. An engine control apparatus comprising an internal combustion engine fuelled with gaseous fuel comprising:
a control unit programmed to:
monitor gaseous fuel pressure;
control a gaseous fuel pumping apparatus to pump liquefied gaseous fuel;
actuate a fuel injection apparatus to introduce gaseous fuel into a combustion chamber of said internal combustion engine; and
monitor the quantity of gaseous fuel remaining in a liquefied gaseous fuel storage vessel.

19. The engine control apparatus of claim 18, wherein said internal combustion engine is fuelled with a liquid fuel, said control unit further programmed to:
monitor liquid fuel pressure;
control a liquid fuel pumping apparatus to pump liquid fuel; and
actuate said fuel injection apparatus to introduce liquid fuel into said combustion chamber.

20. The engine control apparatus of claim 18, said control unit is further programmed to at least one of:
actuate a positive ignition source;
monitor at least one of inlet manifold temperature, inlet manifold pressure, engine coolant temperature, oil pressure, oil temperature, exhaust gas oxygen concentration, engine speed, engine position and ignition switch position; and
command a throttle valve actuator.

21.-22. (canceled)
